(19) United States
(12) Patent Application Publication
(10) Pub. No.: US 2017/0120483 A1
(43) Pub. Date: May 4, 2017

(54) CROWN ADJUSTING ROLL

(71) Applicant: THE JAPAN STEEL WORKS, LTD., Tokyo (JP)

(72) Inventor: Koji SHINOBUDANI, Hiroshima-shi (JP)

(73) Assignee: THE JAPAN STEEL WORKS, LTD., Tokyo (JP)

(21) Appl. No.: 15/341,158

(22) Filed: Nov. 2, 2016

(30) Foreign Application Priority Data
Nov. 4, 2015 (JP) 2015-216582

(51) Int. Cl. B29C 43/46; B29C 43/24; B29C 47/00

(52) U.S. Cl. CPC B29C 43/46; B29C 47/004; B29C 43/24; B29K 2079/08

(57) ABSTRACT

A bearing is provided which supports an inner pipe flange part. An end face flange is formed so as to be inclined on a center of an inner flange part as a supporting point and a load is applied by a pushing and pulling device through the bearing in a direction intersecting at right angles to an axial direction of a roll to incline the end face flanges at both sides by prescribed angles. Thus, a rotation moment is applied to an end face of the outer cell to adjust a crown of the outer cell.

This application claims priority from Japanese Patent Application No. 2015-216582 filed on Nov. 4, 2015, the entire subject-matter of which is incorporated herein by reference.

### TECHNICAL FIELD

The disclosure relates to a roll which applies a pressure to a long sheet shaped material and, more particularly, to a crown adjusting roll which can vary a linear pressure distribution in a direction of width to be pressurized.

Further, the disclosure may be applied to a molding roll of a manufacturing machine of a resin film and sheet and to a touch roll which pressurizes and molds a material by one pair of molding rolls, and is suitable for a molding roll which obtains a thin resin film and sheet.

Here, words and phrases used in the present specification will be described below.

Linear pressure: means a force N per cm in a longitudinal direction of a roll at the time of pressing by one pair of rolls, for instance, 100N/cm (10.2 kg/cm). The “linear pressure” is also referred to as nip pressure.

Crown: When a pressure is applied by one pair of rolls, the rolls are bent and a linear pressure in the center of width of the roll becomes low, an outside diameter of the roll is previously formed to be larger in a center than that in an end part so as to obtain a uniform linear pressure in the direction of width when a load is applied. The crown is ordinarily worked to have a circular arc configuration. When the diameters in the center and the end part are supposed to be D1 and D2, the crown is expressed by D1-D2. Further, the crown may sometimes imply a crown in radius/(radius). In this case, the crown has a value ½ times as long as a crown in the diameter.

### BACKGROUND

In the rolls which can adjust the crown, the roll which is suitable for the molding roll of the resin film and sheet manufacturing machine has been already put to practical use (see, for instance, JP-A-2007-175972, JP-A-6-65889, Japanese Patent No. 3194904 and JP-A-2011-116027).

Further, as a known method, there is a method that in a calender roll which has rigidity and a high linear pressure as high as about 1000N/cm, a shaft is extended to be long to forcedly bend the shaft from outside and change a liner pressure distribution on a the surface of the roll.

In the molding roll of the resin film and sheet, a thin sheet molding roll includes below-described examples.

Ordinarily, a molten resin extruded from a T die is held by one pair of molding rolls having rigidity and molded or formed in a sheet shape and cooled.

A transparent and clear sheet having a thickness of 0.1 mm or smaller is liable to generate an unevenness in thickness in the direction of width of the sheet and immediately harden on the surface of the roll, so that a uniform pressing force (touch) is hardly applied to an entire surface in the width of the sheet and longitudinal stripes are liable to be generated due to an uneven touch.

On the other hand, when a nip pressure is increased, the unevenness in touch is reduced. However, an internal stress in the sheet is increased. Thus, since an optical unevenness is generated in a polarizing film for an optical use, the film cannot be used. In order to cope with this problem, a flexible roll is known in which the thickness of an outer cell is decreased.

In the above-described related arts, JP-A-2007-175972 discloses a structure in which a thin film metallic outer pipe body is allowed to come into contact with an inner pipe roll arranged in a roll and covered with rubber to back up the outer pipe body by an eccentric device, and an internal pressure of the inner pipe roll is expansively changed from outside to adjust a crown.

However, since the structure disclosed in JP-A-2007-175972 is complicated and the eccentric mechanism comes into contact with temperature adjusted liquid, there is a fear in view of durability, an abrasion and a leakage of liquid of a seal.

Further, JP-A-6-65889 discloses a structure in which a fixed shaft is provided in a roll, 5 to 10 hydraulic cylinders are arrange in the fixed shaft to push a rotating outer cell 5 from inside, ends of rods of the hydraulic cylinders have sliding bushes so as to slide the outer cell 5. Pressing forces of the individual hydraulic cylinders are adjusted in directions of width to form various roll crowns in the outer cell 5.

However, in the structure disclosed in JP-A-6-65889, the structure of the roll is complicated and expensive and the outer cell 5 is pressed by the cylinders from the inside, so that frictional resistance of the end bushes is high.

Further, the Japanese Patent No. 3194904 discloses a roll for manufacturing a thin film and sheet in which a thickness t of a thin outer pipe of a double pipe roll is set to 0.03 times or smaller as low as a radius of the roll. Namely, in the double structure including an inner cell and an outer cell, the outer cell is formed in a metallic thin structure and the outer cell is resiliently deformed by following an outer periphery of a main roll by a pressing load to the main roll.

However, the structure disclosed in the Japanese Patent No. 3194904 has no crown adjusting function. Accordingly, in the double structure including the outer cell and the inner cell, the metallic thin cell as the outer cell is resiliently deformed by following the outer periphery of the main roll by the pressing load to the main roll. A contact width between the rolls is increased and a uniform nip is obtained in the direction of width of the roll. The roll is the double pipe roll and the thickness t of the thin outer pipe is set to 0.03 times or smaller as low as the radius of the roll and has more resiliency than that of an ordinary roll. However, since the outer cell is thin, this roll is liable to be deformed during its manufacture, so that the roll is hardly worked.

Further, JP-A-2011-116027 discloses a structure in which a groove is formed in an inner surface of an outer cell to increase a flexibility of the cell and manufacture a large roll and a cooling performance is enhanced.

However, the structure disclosed in JP-A-2011-116027 can manufacture the large resilient roll, however, has no crown adjusting function.

### SUMMARY

According to one illustrative aspect of the disclosure, there may be provided a crown adjusting roll comprising: a cylindrical outer cell configured to pressurize a sheet, wherein each of end portions of the roll comprises: a roll shaft; a first bearing configured to support the roll shaft; an end face flange configured to support the outer cell on one of end faces of the roll at both sides of the outer cell, the end face flange comprising: an outer flange part configured to fix the outer cell; an inner flange part provided inside of the roll in a direction of width of the roll and fixed to the roll shaft; and an inner pipe flange pipe that connects the outer flange part to the inner flange part; and a second bearing configured to support the inner pipe flange part, wherein the second bearing is configured to incline the end face flange on a center of the inner flange part as a supporting point, and the end face flange is inclined by a prescribed angle by applying a load in a direction intersecting at a right angle to an axial direction of the roll through the bearing by a pushing and pulling device such that a rotation moment is applied to an end face of the outer cell to adjust a crown.

The crown adjusting roll may be configured to further comprise a cylindrical inner cell provided in the outer cell and having an outside diameter that is smaller than an inside diameter of the outer cell, wherein the inner cell is integrally formed with the inner flange part.

The inner piper flange part of the end face flange may be extended outside in the axial direction of the roll from the outer flange part of the end faces of the roll, and the second bearing may be provided outside in the axial direction of the roll from the inner flange part.

The pushing and pulling device may be attached to a bearing box provided with the first bearing, and the bearing box may be moveable and pressurizable in a pressurizing direction of the sheet by a pressurizing device.

The crown adjusting roll may further comprise a third bearing provided inside in a radial direction of the second bearing and configured to support the roll shaft; and an eccentric ring fitted to an inner ring of the second bearing and an outer ring of the third bearing respectively, the eccentric ring may have a double ring structure, a rotating position of the double ring may be adjusted so as to adjust an eccentric quantity, and the eccentric quantity may be adjusted to individually incline the end face flanges by angles of ±θ on the inner flange part as a center so that the rotation moment is applied to the end faces of the outer cell to adjust the crown of the outer cell.

The eccentric ring may have the double ring structure or a triple ring structure, an axial position of the ring may be adjusted to adjust the eccentric quantity, and the eccentric quantity may be adjusted to individually incline the end face flanges by angles of ±θ on the inner flange part as the center so that the rotation moment is applied to the end faces of the outer cell to adjust the crown of the outer cell.

The eccentric ring may have the double ring structure comprising an inner ring and an outer ring, and the inner ring and the outer ring may be respectively rotated to adjust the eccentric quantity and an eccentric direction and individually incline the end face flanges by angles of ±θ on the inner flange part as the center so that the rotation moment is applied to the end faces of the outer cell to adjust the crown of the outer cell.

The second bearing may be an aligning roller bearing or an aligning ball bearing having an aligning property.

The end face flanges may be configured to allow temperature adjusting liquid to be circulated in a space between the outer cell and the inner cell and to internally seal the temperature adjusting liquid by the end faces of the roll.

The crown adjusting roll may further comprise a cylindrical partition plate provided between the end face flange and the outer cell and configured to allow circulation of temperature adjusting liquid to an end part of the roll, the partition plate being installed such that one end of the partition plate is supported by the inner cell or the shaft at a center part of the roll.

The inner flange part may have a tapered shape or a diaphragm shape and is configured to incline the end face flange by a bending angle ±θ on the center of the inner flange part as the supporting point, and the end face flange may be inclined by the pushing and pulling device or the eccentric ring such that the rotation moment is applied to the end face of the outer cell such that the crown of the outer cell is adjusted.

The inner flange part may be provided in a position of the end face of the outer cell or outside in the direction of width of the roll, and an inside diameter side of the inner flange part may be fixed to the roll shaft or the inner cell.

The roll may comprise at least two pressing rolls, each of which is a crown adjusting roll for pressurizing and molding a resin sheet that pressurizes and molds a molten resin sheet.

The roll may be a thin, metallic and resilient crown adjusting roll for molding a sheet having a plurality of ring shaped grooves or thread shaped grooves formed in an inner surface of the outer cell.

A hole or a shaft of a tapered part, to which a working jig is fitted, may be provided in an outside part in the end face flange of the end face of the roll or the inner pipe flange part in a longitudinal direction of the roll shaft, and the working jig may have a hole at a center, the hole may be fitted to the roll shaft, and a tapered part fitting part of the tapered part may be provided on an outer peripheral part thereof, so that the rigidity of the end face flange and the outer cell is increased by integrally forming with the roll shaft at the time of working the roll.

A tapered part may be formed at an outside part of the inner pipe flange part, the inner pipe flange part and the roll shaft may configure a recess therebetween at the end face of the roll, and a working jig, an outer surface of which is formed to have a tapered surface and which has a hole at a center, may be fitted to the recess such that the tapered surface of the working jig is fitted to the tapered part of the inner pipe flange part and the roll shaft is inserted into the hole.

### BRIEF DESCRIPTION OF THE DRAWINGS

FIG. 1 is a schematic diagram of a sheet molding device using a crown adjusting roll of the disclosure:

FIG. 2 is a sectional view of the crown adjusting roll of the disclosure, taken along a section II-II in FIG. 1:

FIG. 3 is a detailed and partly sectional view of the crown adjusting roll of a first exemplary embodiment of the disclosure;

FIG. 4 is a sectional view with the crown adjusting roll cut by a plane vertical to an axial direction, which is seen from an arrow IV-IV in FIG. 3:

FIG. 5A is a structure diagram of the roll, and FIG. 5B is a diagram of a deformed form of the roll when a crown is adjusted;

FIG. 6 is an enlarged view of a deformed form of the roll when there is a crown adjusting load shown in FIG. 5;

FIGS. 7A and 7B are diagrams of a deformed form of a roll (a related-art roll) when a linear pressure is applied:

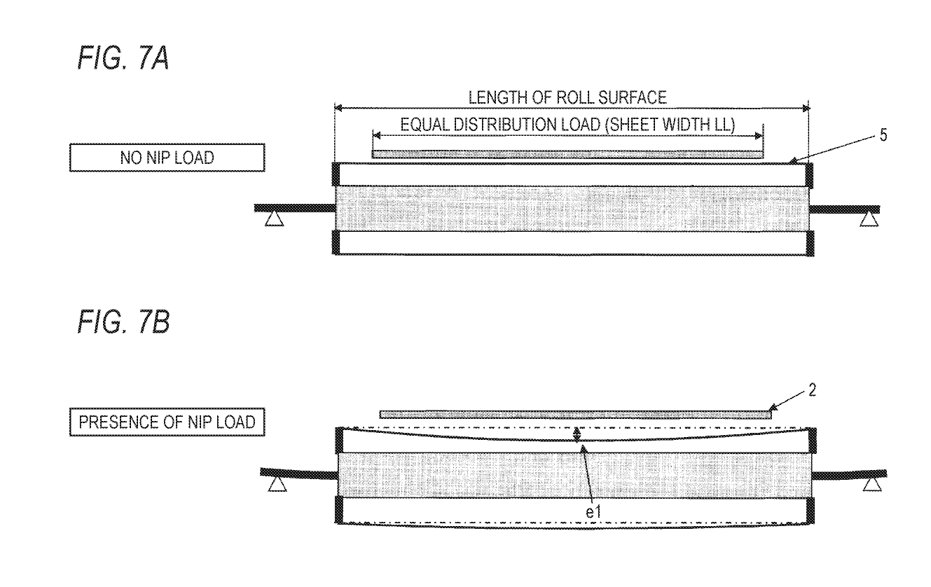

FIG. 8 is a detailed sectional view of a sheet molding roll of a second exemplary embodiment of the disclosure;

FIGS. 9A and 9B are explanatory views of an operation of an eccentric ring of the second exemplary embodiment of the disclosure:

FIG. 10 is a structure diagram of a crown adjusting roll of a third exemplary embodiment of the disclosure;

FIG. 11 is a diagram showing a linear pressure distribution change of the first exemplary embodiment;

FIG. 12 is a diagram of a deformed form of the roll of the first exemplary embodiment;

FIG. 13 is an installation diagram of a working jig:

FIGS. 14A1, 14A2 and 14B are explanatory views of an operation of a slide type eccentric ring; and

FIG. 15 is a structure diagram of a crown adjusting roll (other exemplary embodiment of the disclosure).

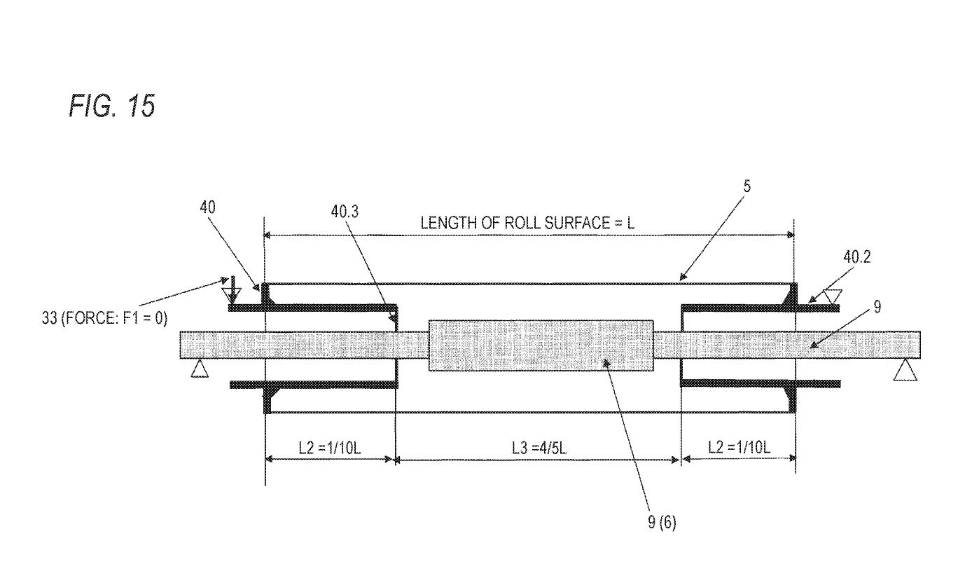

### DETAIL DESCRIPTION

Illustrative aspects of the disclosure provide a crown adjusting roll having below-described functions:

1. A roll which has no leakage of liquid and has a high reliability is obtained as a crown adjusting roll.
2. A roll can be obtained which can carry out various kinds of crown adjustments and can be also used as a simple and inexpensive guide roll for touching.
3. A crown adjusting roll is obtained which can be used for a sheet molding resilient roll.
4. A crown adjusting roll is obtained which has little frictional resistance during a rotation and driving.

Hereinafter, exemplary embodiments of a crown adjusting roll of the disclosure will be described with reference to the drawings.

### First Exemplary Embodiment

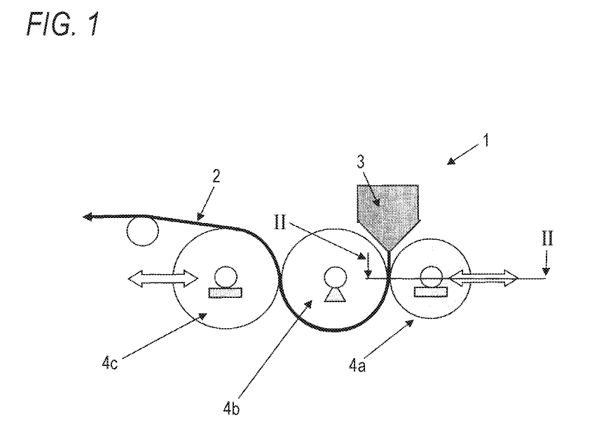

FIG. 1 to FIG. 6 show one exemplary embodiment (refer it to as a “first exemplary embodiment”, hereinafter) of a crown adjusting roll of the disclosure.

FIG. 1 shows an entire structure of a resin sheet molding device 1 to which a crown adjusting roll 4a (it is sometime referred to as a “molding roll”) for molding a sheet in the disclosure is applied.

A sheet 2 molded or formed by the resin sheet molding device is a transparent and clear sheet as thick as 0.05 mm to 1 mm or so. The resin sheet molding device is applied to a use for molding a resin material such as PC, PMMA, PET, COC, PP or the like.

The crown adjusting roll 4a of the first exemplary embodiment is used to manufacture at high speed a thin film sheet of about 0.1 mm which is hardly molded or formed by a related-art rigid roll.

Further, when the sheet is partly unevenly pressed (a non-pressed part is generated), a roll crown is changed to be symmetrical or asymmetrical right and left, so that an unevenness in press can be eliminated or the crown is increased or decreased to change vertically a flat liner pressure distribution.

The resin material from an extruding machine is extruded from in a sheet form by a T die 3 to guide the sheet material to a roll gap (a nip part) of one pair of molding rolls 4a and 4b.

The molding roll 4b is fixed and other molding rolls 4a and 4c are formed so as to be movable in a horizontal direction by a pressurizing device.

The molding roll 4b is ordinarily rotated at the same speed and pressed by a uniform pressure in the direction of width of the roll to mold or form the resin material to a sheet having a prescribed thickness.

The sheet is wound on the molding roll 4b side and nipped and molded or formed by the molding roll 4c (further, other molding roll not shown in the drawing) as required, supplied downstream, cooled and then wound up or cut to manufacture the sheet.

The molding g roll 4b is an ordinary rigid roll which is plated and reflectively finished. Further, temperature adjusted liquid is supplied to the roll to cool and heat the roll.

The three molding rolls 4a, 4b and 4c shown in FIG. 1 are formed so as to have the same roll surface length.

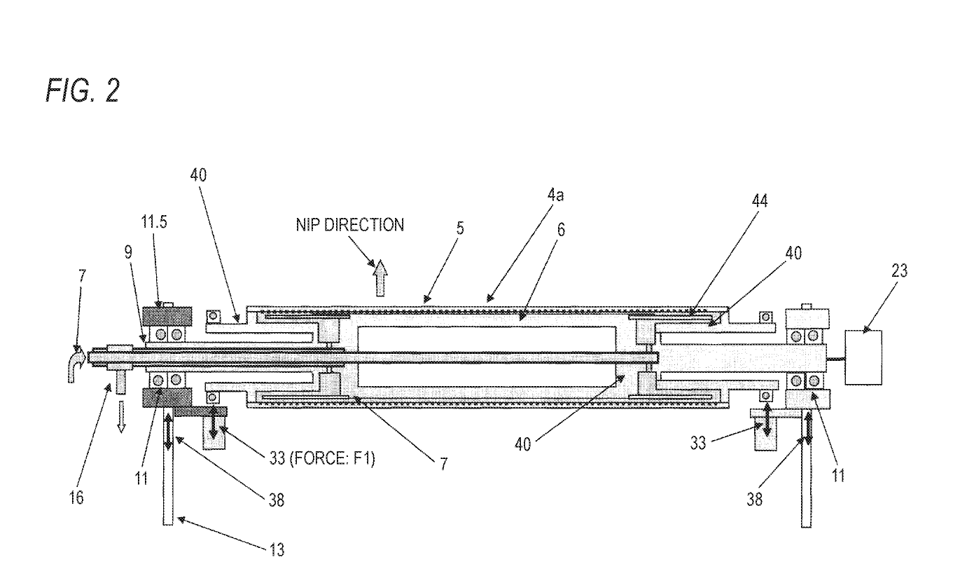

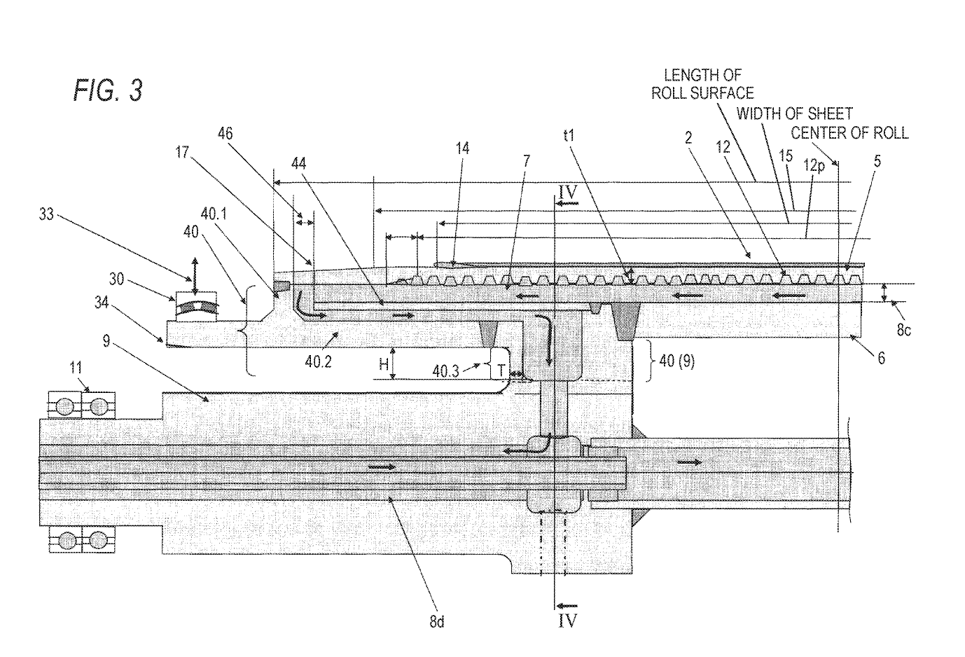

FIG. 2 shows an entire part of the first exemplary embodiment of the crown adjusting roll 4a of the disclosure and FIG. 3 shows a detail of the crown adjusting roll 4a.

[Specification of Molding Roll 4a] (Refer to FIG. 2 to FIG. 6)

The specification of the molding roll 4a is described below.

Form of an outer cell roll: outside diameter Ø of 300 mm×thickness of 5 mm×length of surface of 1400 mm

Width of sheet: 1100 mm Distance between bearings: 1660 mm

Nip pressure (linear pressure): 100 N/cm

Form of a groove 12: trapezoidal female thread of depth of 2.3 mm, pitch of 4 mm

Length L2 of flange part of inner pipe: 140 mm

Thickness of inner cell: 20 mm

[Structure of Molding Roll 4a]

The molding roll 4a is formed by a double pipe roll structure including an integrally formed inner cell 6 and an outer cell 5 having an inside diameter larger than an outside diameter of the inner cell 6.

A feature of the crown adjusting roll resides in that an end face flange 40 of an end face of the roll is formed to be long in an axial direction and a length L2 of an inner pipe flange part is about 1/10 times as long as a length L of the roll. A length L3 of rigid inner cell is about ⅘ times as long as the length L of the roll.

The molding roll 4a has an ordinary double pipe structure and temperature adjusting liquid 7 is supplied to a gap space between the inner cell 6 and the outer cell 5.

Further, an entire part of the roll is rotated through roll shafts 9 and bearings 11 at both ends like an ordinary molding roll.

A motor 23 is connected to a driving side of the roll shaft 9 to rotate and drive the entire part of the roll through the roll shaft 9 at prescribed speed.

The outer cell 5 is made of steel, formed to be thin (thickness of outer cell t1=5 mm) and used for molding a thin film sheet.

The inside diameter of the outer cell 5 is formed to be larger by about 20 mm than the outside diameter of the inner cell. Accordingly, a space serving as a passage 8c in which the temperature adjusting liquid such as cooling water is fed is 10 mm. Thus, a sufficient flow rate can be supplied.

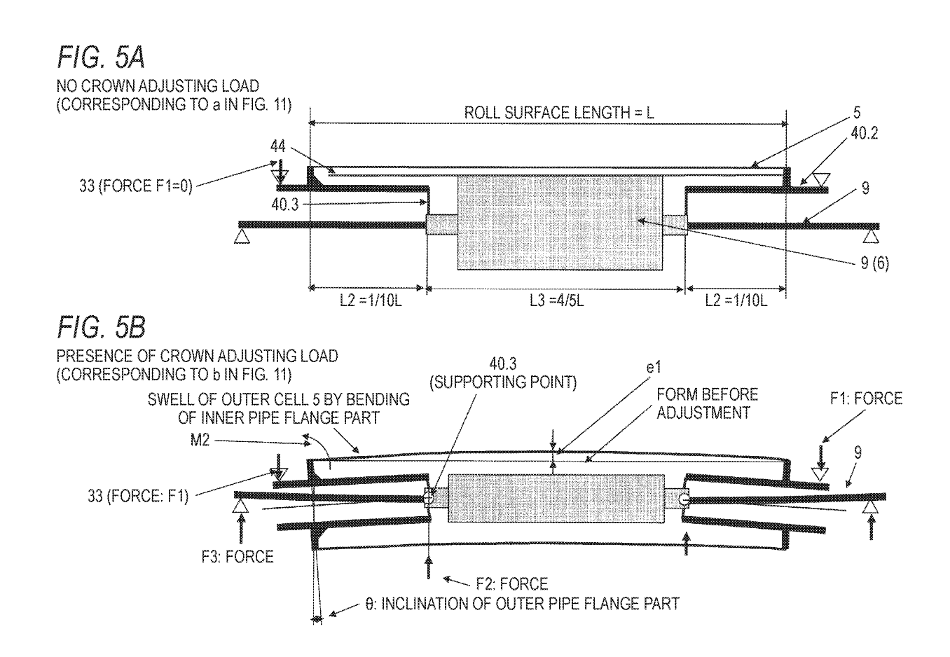

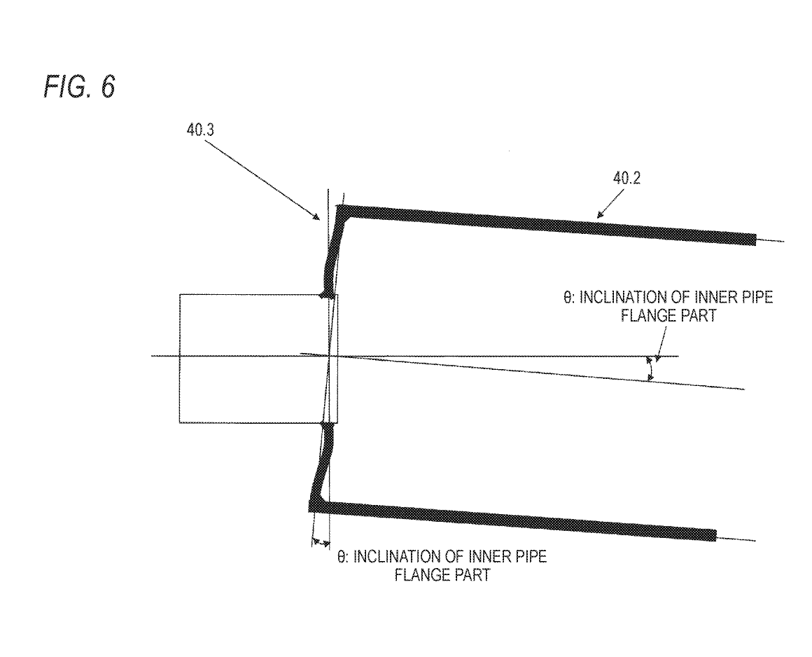

As shown in FIG. 3, in the detailed structure of the molding roll 4a, since the outer cell 5 is thin, the thickness of the inner cell 6 is formed to be larger than that of the outer cell 5 in order to maintain a high rigidity of the entire part of the roll.

[End Face Flange 40] (Refer to FIG. 3, FIG. 5 and FIG. 6)

An end face flange is formed with three parts including an outer flange part 40.1 connected to the outer cell 5 and the roll shaft 9, a cylindrical type inner pipe flange part 40.2 and an inner flange part 40.3 fixed to the shaft.

In the first exemplary embodiment, the outer flange part 40.1 and the inner pipe flange part 40.2 of the end face flanges 40 at both ends of the roll are welded together.

The inner pipe flange part 40.2 is extended more outward from the end face of the roll and a bearing 30 (bearing for inner pipe flange part) is fitted to an outer periphery in an end part. The bearing 30 is accommodated in a bearing box not shown in the drawing so that an outer part of the bearing box can be pushed and pulled by a pushing and pulling device 33.

The pushing and pulling device 33 is fixed and installed in a bearing box 11.5 of the bearing 11 of the roll shown in FIG. 2.

[Outer Flange Part 40.1]

An outer side of an upper end of the outer flange part 40.1 of the end face flange 40 is welded and connected to the outer cell 5. In the outer flange part 40.1, the thickness of the flange is formed to be large to increase the rigidity.

[Inner Pipe Flange Part 40.2]

The inner pipe flange part 40.2 is formed in the shape of a cylindrical pipe to connect the outer flange part 40.1 to the inner flange part 40.3 by welding. Further, the thickness of the cylindrical part of the inner pipe flange part 40.2 is formed to be large like the inner cell 6 so as to have a rigid structure.

Further, the bearing 30 is attached thereto. Length L2 of the inner pipe flange part 40.2 shown in a structure diagram of FIG. 5 is 140 mm.

[Inner Flange Part 40.3]

The inner flange part 40.3 is formed in a thin disk shape and cut and worked integrally with the shaft. In a large roll, the inner flange part 40.3 and the roll shaft 9 are welded and connected together. The inner flange part 40.3 is formed in the thin disk shape to support the outer cell 5 and is formed so as to slightly incline an axis by ±θ as a supporting point of the end face flange 40.

As shown in FIG. 3, in the first exemplary embodiment 1, the end face flange is formed with two of the inner flange part 40.3 and the inner cell 6 side with a circulating groove 41 held between them. The end face flange part of the inner cell 6 side of the latter is welded to the inner cell 6 in the center part of the roll in the direction of width of the end face flange.

[Roll Shaft 9]

The end face flange 40 is welded to the roll shaft 9. In the central part of the end face flange 40, the circulating groove 41 of the temperature adjusting liquid is engraved in a ring form.

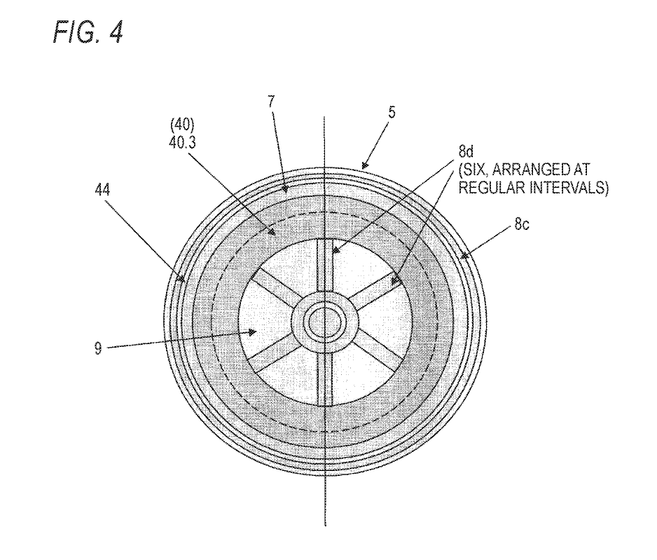

In a bottom surface of the circulating groove 41, six passages 8d of sectional configurations of C are axially formed in radial directions as shown in FIG. 4.

[Partition Plate 44]

In the first exemplary embodiment, as shown in FIG. 3, a partition plate 44 is arranged in an intermediate part of a space between the inner pipe flange part 40.2 and the outer cell 5 and serves to guide the temperature adjusted liquid to the end face of the roll and supply the temperature adjusting liquid to the entire width of the outer cell 5.

Accordingly, the partition plate 44 is welded and fixed to an outer periphery of the inner flange part 40.3 of the end face flange and has a structure of a cantilever.

The partition plate 44 has a slit 46 (a gap) formed between the outer flange part 40.1 of the end face flange 40 and the partition plate 44.

[Groove 12 in Inner Surface of Outer Cell 5]

In an inner surface of the outer cell 5, a thread shaped groove (recessed part) 12 is formed.

In the first exemplary embodiment, the groove has a form of one line of trapezoidal female thread with a pitch of 4 mm.

As shown in FIG. 3, a range of a groove work is set to be a little larger than the width of the sheet. Two parts in both end parts of the groove work have incomplete grooves formed.

To an inner surface of the outer cell 5, a plating film is applied which prevents a corrosion of the cell made of steel.

[Crown]

In a molding range (a crown forming part 15 (a roll molding width)) on an outer periphery of the outer cell 5, a surface is plated with chromium and then reflectively finished to form a crown.

In the crown, since the outer cell 5 is bent by a nip load, the center of the roll is previously formed to be high so that a uniform linear pressure nip may be obtained under a state that the nip is applied.

The molding roll 4b is a rigid roll and has a thick cell, so that under the linear pressure of 100N/cm, a deformation flexure or bending is so small as to be negligible.

Accordingly, the molding roll 4a is formed so as to be high in its center so that a roll surface is linear during a nipping operation.

Ordinarily, a linear pressure of the crown roll in which a uniform linear pressure nip is obtained in the direction of width of the roll is referred to as a design linear pressure. In this case, the design linear pressure is 100N/cm.

In the case of the first exemplary embodiment, the radius of the crown is 0.3 mm.

The crown forming part 15 (the roll molding width) which forms the crown is configured to be larger than the width of the sheet. The crown forming part 15 (the roll molding width) may be configured to be larger than a width of a recessed part forming part 12p where the grooves (recessed parts) 12 are formed. When the transparent and clear sheet is molded or forming, the crown forming part 15 is formed as a reflective part.

The crown is limited to a range of the crown forming part 15.

A range of the outer periphery of the roll to the end face of the roll is provided with a tapered part 17 to prevent a contact with the molding roll 4b. The radius is reduced more by 1 mm or so, so that the range of the crown forming part 15 is discriminated.

[Temperature Adjusting Function] (Refer to FIG. 2 to FIG. 4)

The temperature of the roll is controlled by circulating the temperature adjusting liquid 7 supplied to the outer cell 5.

The molding roll 4a is heated and cooled by the same structure as that of an ordinary cooling roll to supply from outside and discharge the temperature adjusting liquid 7 in a rotary joint 16 provided in the roll shaft 9 of an operation side and continuously adjust the temperature of the molding roll 4a.

In a flow of the temperature adjusting liquid 7, the temperature adjusting liquid is supplied to a driving side from a central passage of the rotary joint of the operation side, passes the passages 8d formed with the six holes of the end face flange in a driving side of the roll shaft 9 and enters the ring shaped circulating groove 41.

FIG. 3 is a detailed diagram of the section of the roll of the operation side. Accordingly, the temperature adjusting liquid is supplied in an opposite direction to that of the driving side.

The flow of the driving side is described by using FIG. 3. The temperature adjusting liquid expanded in the ring shape in the circulating groove 41 is guided by the partition plate 44 and supplied to the end face flange side through the space to the inner pipe flange part 40.2, passes through a ring shaped gap of the slit 46 and is supplied to the passage 8c in the inner surface of the outer cell 5 in the shape of a ring throughout an entire width of the roll.

The flow of the temperature adjusting liquid in the operation side is opposite to that of the driving side.

FIG. 4 shows an arrangement of the passages 8d formed with the six holes (the operation side has the same structure as that of the driving side).

In the inner flange part 40.3 of the end face flange, the temperature adjusting liquid passes through the six passages 8d and an outer peripheral passage of the rotary joint of the operation side and enters an external temperature adjusting device.

The temperature adjusting device has a function for keeping the temperature of the temperature adjusting liquid 7 to be constant.

[Pressurizing Device 38]

The bearing 11 which supports the roll shaft 9 of an entire part of the molding roll 4a is provided with a pressurizing device 38 capable of pushing in a horizontal direction through the bearing box 11.5. The pressurizing device 38 ordinarily uses a pneumatic or hydraulic cylinder.

A movement of the bearing box 11.5 is supported by a linear guide 13 and the roll can be moved in parallel.

[Advantage of End Face Flange 40]

The inner flange part 40.3 is formed in the thin disk shape to support the outer cell 5 and can slightly incline the axis by ±θ as the supporting point of the end face flange 40.

The inclination θ is 0.2° or smaller in the first exemplary embodiment to ensure a fatigue failure strength of a material or more.

Further, since the inner flange part 40.3 is formed in the disk shape, the inner flange part ensures a sufficient strength to a vertical load, namely, a linear pressure, a roll tare load and a below-described crown adjusting force F1.

[Deformation of Outer Cell 5 by Crown Adjusting Mechanism] (Refer to FIG. 5 and FIG. 6)

FIG. 5 and FIG. 6 show diagrams of deformation of the roll at the time of an ordinary crown (FIG. 5A) when the crown of the molding roll 4a is not adjusted and when the crown is increased to a protruding form (FIG. 5B and FIG. 6).

FIG. 5A shows an example of the ordinary crown when the crown is not adjusted and a state that a force F1 of the pushing and pulling device 33 is zero.

The outer cell 5 is shown by a straight line. Actually, the outer cell has a little protruding crown, however, the outer cell 5 is shown by the straight line for an explanation.

FIG. 5B and FIG. 6 show a state that the crown is increased to the protruding form and the force F1 of the pushing and pulling device 33 pushes the inner pipe flange part 40.2 to the roll shaft 9 side from a nipping direction.

An entire part of the inner pipe flange part 40.2 is formed so as to have a rigidity. Since only the inner flange part 40.3 is formed in the thin disk shape and to be deformable like a leaf spring, the outer cell 5 is bent by an angle θ on the inner flange part 40.3 as a center.

Since the outer flange part 40.1 is welded to the outer cell 5, a rotation moment M2 shown in FIG. 5B and FIG. 6 is generated. Further, a similar force F1 is applied to an opposite side in the direction of width of the roll to deform the outer cell 5 in a mountain shape from both sides of the roll.

When a bending quantity (a crown adjustment quantity) of the outer cell 5 in the center of the roll shown in FIG. 5B and FIG. 6 is supposed to be e1, a substantial crown (a radius reference) of the roll is obtained by increasing more the crown by e1 (a protruding load).

In the case of FIG. 3, FIG. 5B and FIG. 6 of the first exemplary embodiment 1, when a moment load 1000N·m is applied to both the ends of the roll, the bending quantity (the crown adjustment quantity) e1 is 0.050 mm/radius reference.

In this connection, a design crown quantity in the first exemplary embodiment is about 0.32 mm/radius reference.

[Relation Between Forces F1, F2 and F3 when Crown is Adjusted] (Refer to FIG. 2, FIG. 5 and FIG. 6)

F1=the force of the pushing and pulling device 33 of the crown adjusting mechanism

F2=a force (a nipping direction) in the radial direction of the inner flange part 40.3

F3=a force of the pressurizing device 38

When there is no nip load, F1=F2, F3=0

The directions of the forces are set in such a way that the forces are respectively balanced. In the forces, a pushing force and a pulling force (+ and −) (see FIG. 5 and FIG. 6).

When there is the nip load, F1=the same value when there is no nip load, F2=the nip load added to F1, F3=added by the nip load

[Operation of Pushing and Pulling Device 33 of Crown Adjusting Mechanism] (Refer to FIG. 2)

The pushing and pulling device 33 is installed in the bearing box 11.5. As shown in FIG. 2, two bearings 11 are provided so that the bearing box 11.5 has a structure which can resist even when the rotation moment is applied due to an operation of F1.

Further, even when the entire part of the roll is moved to the molding roll 4b side, since the crown adjusting device is moved together, a crown adjusting force is not changed.

The bearing 11 and the bearing box 11.5 have the same structures as those in an opposite side of the width of the roll. Accordingly, independent operations can be made in both sides in the direction of width.

[Automatically Aligning Function of Bearing 30]

Since the bearing 30 uses an automatically aligning roller bearing shown in FIG. 3, even when an entire part of the end face flange 40 is inclined by an angle θ, the roll can be rotated with the end face flange kept inclined.

In the first exemplary embodiment, the automatically aligning roller bearing is used. However, since an automatically aligning ball bearing has an aligning function, the automatically aligning ball bearing can be used.

[Structure of Thin Metal Resilient Roll] (Refer to FIG. 2 and FIG. 3)

In the thin film sheet, it is difficult to supply uniformly and thin the molten resin by the T die, so that unevenness in thickness is liable to arise in the thickness of the sheet in the direction of width.

Further, since the sheet is thin, even when the sheet is pressed by a roll nip, the resin little flows in a transverse direction in the nip part, non-pressed parts of vertical stripes are liable to be generated in the sheet.

The roll of the present exemplary embodiment is provided with the grooves 12. Since each of the grooves has an independent flexibility for the deformation in the axial direction of the roll, the nip is easily formed by following the vertical stripes. Accordingly, even in the thin sheet, the vertical stripes are hardly formed and the thin sheet can be molded or formed by a double side touch.

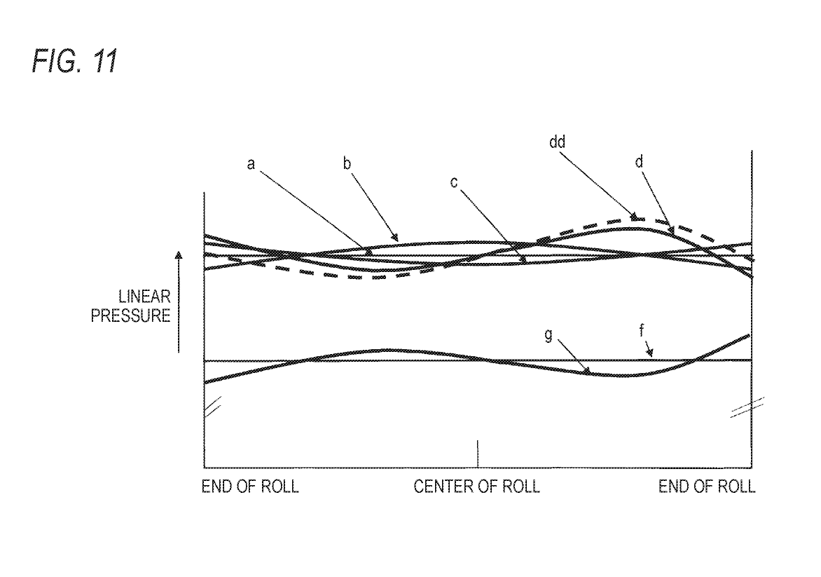

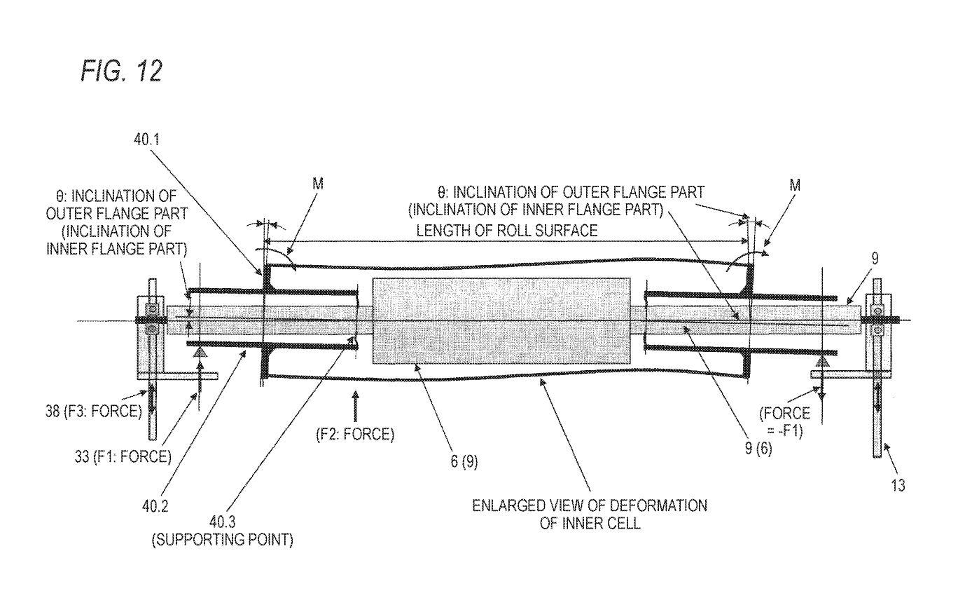

Further, since the outer cell 5 is thin, when the end face flange 40 is inclined, the outer cell 5 is easily deformed so as to easily adjust the crown.

[Changed Pattern of Crown Adjustment] (Refer to FIG. 11 and FIG. 12)

FIG. 11 shows linear pressure distribution patterns of various crown adjustments.

In the patterns a to d, forces of the pressurizing device 38 are the same and the same forces in right and left. The patterns f and g show diagrams in which the force of the pressurizing device 38 is lowered. Further, the pattern dd shows that the force of the pressurizing device 38 is asymmetrical in right and left.

Explaining the individual patterns,

Pattern a: A uniform linear pressure curve having no crown adjustment. This a is obtained when the roll of a design linear pressure is nipped by the design linear pressure. When a crown is calculated as planned, a flat linear pressure distribution is ordinarily obtained.

Pattern b: A mountain shaped linear distribution which is a liner pressure distribution obtained by the crown adjustment shown in FIG. 5B an FIG. 6. Since an average linear pressure of this b is the same, the linear pressure in the end part of the roll is lower than that of a, though the linear pressure distribution is mountain-shaped. Further, as described above, when the linear pressure distribution of b is obtained in the first exemplary embodiment, an increase of the crown (see FIG. 5B and FIG. 6) is expressed by e1=about 0.050 mm/radius reference. The crown adjustment quantity e1 can be adjusted by adjusting the force F1 of the pushing and pulling device 33 even during a driving operation.

Pattern c: A linear pressure distribution of a recessed form which is a linear pressure distribution obtained by the crown adjustment that an opposite force to the above-described b, namely, F1=−F1 is applied in FIG. 5B and FIG. 6. Though the linear pressure distribution has the recessed form, the linear pressure in the end part of the roll is higher than that of a.

Pattern d: An S shaped linear pressure distribution which is a linear pressure distribution obtained by a crown adjustment shown in FIG. 12. FIG. 12 shows an S shaped roll cell deformation in which forces of the crown adjustment in right and left are the same and operated in opposite directions to each other.

Pattern dd: An S shaped linear pressure distribution which is a linear pressure distribution obtained by a crown adjustment shown in FIG. 12. However, the force F3 of the pressurizing device 38 is slightly different in right and left. Namely, the force F3 of the pressurizing device 38 in the right side shown in FIG. 12 is allowed to be larger than that in the left side. Accordingly, an average linear pressure in the right half is larger than that of the left side, so that a curve of dd is obtained.

Pattern f: A uniform linear pressure curve having no crown adjustment. This f is a flat linear pressure distribution obtained when the roll is nipped by a design linear pressure lower than the design linear pressure of a.

Pattern g: An inverted S shaped linear pressure distribution which is an inverted form of the S shape shown in the above-described d. Further, g is a linear pressure distribution obtained by lowering a linear pressure average.

As described above, in the various linear pressure distributions shown in FIG. 11, when the pressurizing devices 38 and the pushing and pulling devices 33 in the right and left sides are individually changed in four positions, various crown adjustments can be achieved.

In the first exemplary embodiment, the inner pipe flange part 40.2 is provided which is extended long inside the roll. The length L2 of the inner pipe flange part 40.2 is 1/10 times as long as an entire length of the roll in one side.

Though an illustration is omitted, when a load two times as large as a design linear pressure load is applied, all deformed bending allows the roll to be bent to two times as large as one time pressure.

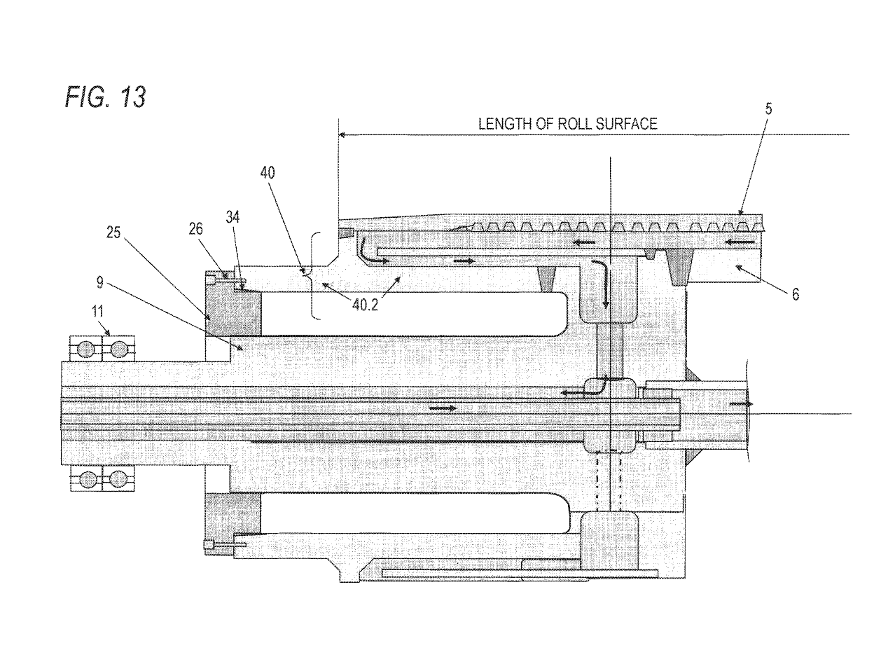

A point of the disclosure resides in that the long end face flange 40 is provided in the thin cell and the rigid roll with a presence or absence of the grooves 12 giving no influence and the same idea is established.

[Operation of Working Jig 25] (Refer to FIG. 13)

FIG. 13 shows a sectional view in which a working jig is installed in the roll.

Since the roll of the disclosure has the end face flange long in the axial direction, there is a fear that the rigidity of the roll is weakened in an outer surface machining or polishing and grinding works of a roll cell so that a highly accurate work cannot be done. Such a jig with rigidity increased is frequently used in jigs of a machine tool and a lathe. In the first exemplary embodiment, a tapered part 34 is provided in an inner surface of an end part in the width direction of the inner pipe flange part 40.2. A working jig 25, an outer surface of which is formed to have a tapered surface and which has a hole at a center, is fitted to the roll shaft 9 from an axial direction with the roll shaft 9 being inserted into the hole of the working jig 25, and the working jig 25 is fixed to the roll shaft 9 by a plurality of bolts 26 to be integrally formed with the roll shaft 9, so that the rigidity of the end face flange 40 is increased.

Thus, the outer peripheral surface machining and the polishing work of the present roll can be accurately carried out and the roll can be worked in the same manner as a roll having an ordinary structure.

[Flow of Temperature Adjusting Liquid 7] (Refer to FIG. 2 and FIG. 3)

The temperature adjusting liquid 7 enters from the rotary joint of the operation side, passes through the pipe, the holes of the driving side shaft, flows in the passage 8c between the inner cell 6 and the outer cell 5 and is discharged from the operation side.

In this roll, the grooves are provided in the inner surface of the outer cell 5 so that a contact area with the temperature adjusting liquid is large. Thus, a cooling ability of the cell is high.

FIG. 3 is a detailed diagram of a section of the roll of the operation side, the temperature adjusting liquid is supplied in an opposite flow to that of the driving side.

As the flow of the temperature adjusting liquid, a turbulent flow ordinarily has a higher heat transfer effect than that of a laminar flow.

Further, a spiral plate used in the usual roll may be wound on the outer periphery of the inner cell to increase a speed of the temperature adjusting liquid, further obtain a laminar flow state and increase the cooling ability.

[Operation of Partition Plate 44] (Refer to FIG. 3)

The partition plate 44 is provided with an outer peripheral surface aligned with the same position as the inner cell 6b to weld and fix an end face of the inner cell 6 side in a state of a cantilever state.

Further, since the slit 46 is circumferentially opened in the gap between the outer flange part 40.1 and the partition plate, the temperature adjusting liquid is guided by the partition plate 44 and supplied along an inner periphery side space and an outer periphery side space and turned in the shape of U in the outer flange part 40.1.

Accordingly, the temperature adjusting liquid is supplied from the end face of the roll to the other end face of the roll in the inner surface of the outer cell.

Since the partition plate 44 welds and fix the end face of the inner cell 6 side in the state of the cantilever, the partition plate 44 is not related to a bending strength of the inner pipe flange part 40.2, the inner pipe flange part 40.2 can be freely displaced.

Further, the temperature adjusting liquid is connected to a circulating pump of an external temperature adjusting device by using the rotary joint in an end of the roll shaft.

[Strong to Internal Pressure]

When the ring-shaped grooves are provided in the outer cell 5 of the resilient roll, the flexibility of the cell to the vertical grooves of the sheet is increased and a mold-ability is increased, however, internal pressure strength is hardly lowered. As a result, the outer cell 5 having the ring shaped grooves is strong to an internal pressure.

[Strong to High Speed]

Since the present roll is integrally formed, the roll can be used like an ordinary roll with no limitation to a speed.

Though the speed is high, since the thin sheet is manufactured by double side touch molding at about 100 m/min at maximum, the roll can be used without a problem.

[Durability]

Since a sliding part is not provided, when a maximum stress of the outer cell 5 is located within a range which meets an allowable strength of a material, the roll has the same durability as that of the ordinary roll.

Further, since the roll is not formed with rubber or plastic as a component material and is entirely formed with metal, the roll has durability.

(Use of Rotary Joint)

The temperature adjusting liquid is supplied to the present roll and discharged from the roll similarly to the ordinary roll, and the rotary joint can be used with no problem for the durability.

[Advantages of Crown Adjustment]

1. The design linear pressure can be adjusted after the roll is manufactured or during a manufacturing of the roll.

In a sheet thinner than an ordinary sheet which cannot be formed by the usual roll, when the linear pressure is increased, unevenness in pressure is more reduced, so that the linear pressure is desired to be increased.

2. A rim part 14 of an end of the sheet can be emphatically pressed (the linear pressure is partly increased) under the same linear pressure to partly improve an insufficient pressure.

In the thin sheet, the pressure is liable to be uneven and insufficient in the vicinity of the rim. Further, on the contrary, the pressure in the vicinity of the rim part can be lowered.

3. An average linear pressure in one side can be raised, so that an S shaped linear pressure distribution can be obtained.

Various linear pressure patterns are shown in FIG. 11.

[Roll Having No Leakage of Temperature Adjusting Liquid]

Since the roll is completely welded and a seal member such as rubber does not come into contact with the temperature adjusting liquid, the roll has no liquid leakage and the durability.

[Roll Used for High Temperature]

Since the roll is entirely welded and made of metal and the seal member such as rubber does not come into contact with the temperature adjusting liquid, the roll can be used without a leakage of liquid using high temperature oil of about 200° C.

As for use for the high temperature, the roll can be used for molding a sheet made of polyimide amino as a resisting material.

### Second Exemplary Embodiment

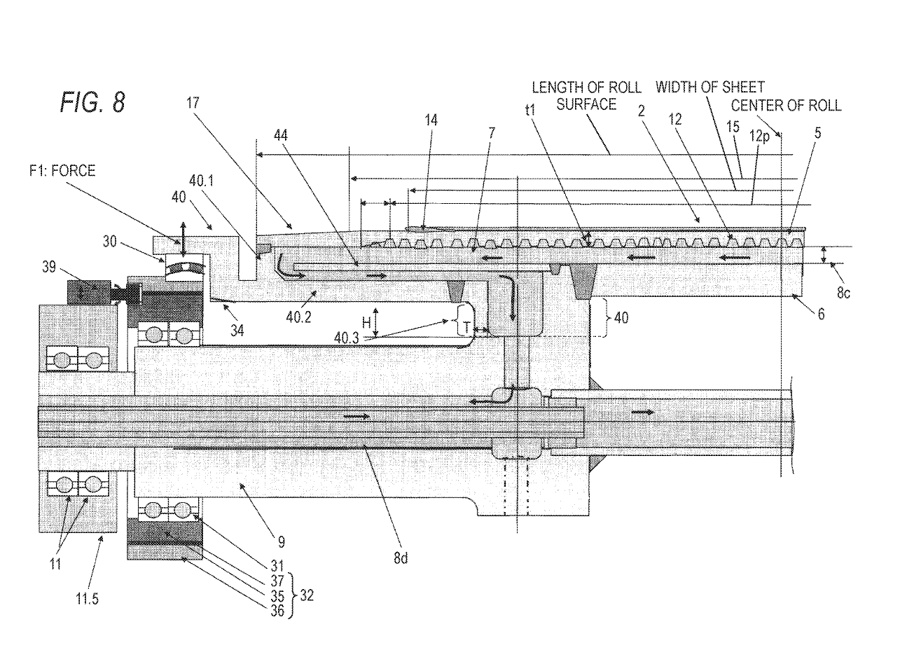

Hereinafter, a second exemplary embodiment will be described. As illustrated in FIG. 8, in the second exemplary embodiment, a structure that the pushing and pulling device of the inner pipe flange part 40.2 in FIG. 3 of the first exemplary embodiment is changed to a structure of a double eccentric ring 32 to apply a force F1 to an inner pipe flange part from a roll shaft 9.

[Detailed Structure of Second Exemplary Embodiment]

A bearing 30 of an automatically aligning roller bearing is internally provided outward in a direction of width of the inner pipe flange part 40.2 and the eccentric ring 32 is provided in an inner ring side of the bearing.

The eccentric ring 32 includes an outer ring 36, an inner ring 35 and an intermediate bush 37 between the rings. A square ring can be rotated and moved.

Further, the two rings have gears formed by locating the intermediate bush 37 at the center and a cam rotating device 39 is engaged with them.

A position of the cam rotating device 39 is changed from the center of a roll shaft depending on respective eccentric directions of the rings. However, a fixing and supporting device not shown in the drawings has rotation stopping and eccentricity adjusting functions (with a motor) of the eccentric ring 32.

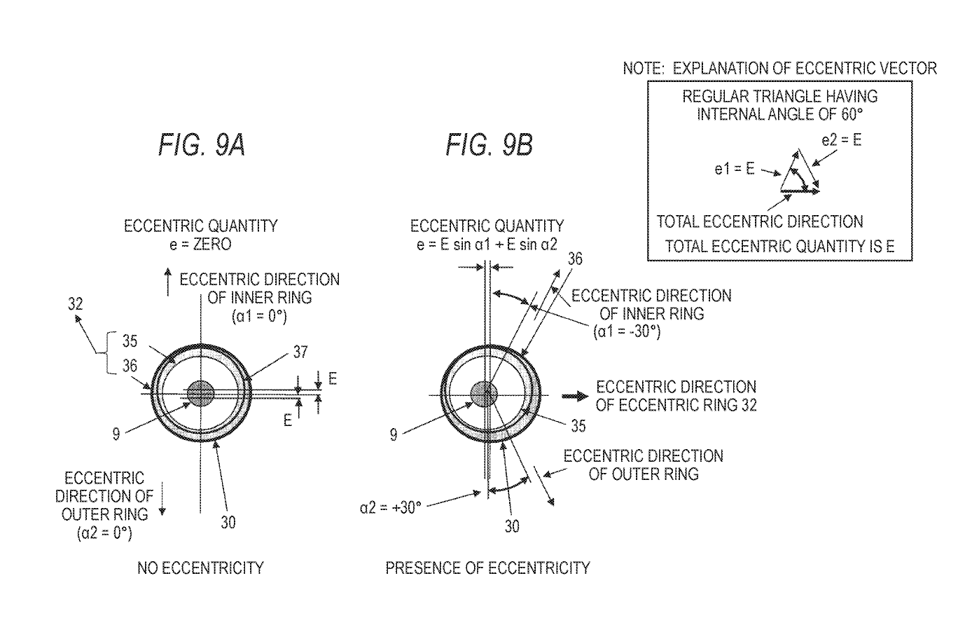

Further, a bearing 31 (third bearing for roll shaft) is fitted between an inner side of the eccentric ring 32 and the roll shaft 9.

[Operation Diagram of Eccentric Ring] (Refer to FIGS. 9A and 9B)

The eccentric ring 32 has a double eccentric ring structure which is arranged as shown in FIG. 9.

FIG. 9A shows a state having no eccentricity. In the inner ring, an upward direction shows an eccentric direction. In the outer ring 36, a downward direction shows an eccentric direction. An eccentric quantity E is respectively the same.

In this arrangement, since the eccentric directions are opposite to each other, the arrangement is a concentric arrangement without an eccentricity, namely, a state having no crown arrangement.

FIG. 9B shows a state having the eccentricity. In the inner ring, a direction in which the inner ring is rotated by 30° rightward from an upper part is an eccentric direction. In the outer ring 36, a direction in which the outer ring 36 is rotated by 30° leftward from a lower part is an eccentric direction. An eccentric quantity E is respectively the same.

In this arrangement, since the eccentric directions are opposite to each other, an eccentric quantity e is respectively expressed by E sin 30=0.5. Thus, e=0.5*2*E=E. Namely, the arrangement shows a state having a crown adjustment. A total eccentric direction shows a right direction having the eccentric quantity of E. A maximum eccentric quantity is expressed by 2*E. In an opposite eccentric direction, an eccentric quantity of −2*E can be obtained.

An example of a structure which rotates the double eccentric ring is shown in FIG. 8.

[Operation of Second Exemplary Embodiment] (Refer to FIGS. 8, 9A and 9B)

When the eccentric quantity of the eccentric ring 32 is adjusted, the eccentric direction and the eccentric quantity and a rotation stop of the eccentric ring 32 can be carried out.

An entire part of a roll can be rotated and driven by a motor of a driving side as shown in FIG. 2.

An end face flange 40 can be inclined by ±θ as shown in the first exemplary embodiment by an eccentric movement and a crown adjustment can be carried out to obtain various linear pressure distributions shown in FIG. 11 as in the first exemplary embodiment.

When the eccentric quantity of the eccentric ring 32 is supposed to be 0.2 mm, the eccentric rings can be respectively adjusted by rotating by ±30°.

As in the present exemplary embodiment, a crown can be adjusted by a little eccentric quantity. When the angle θ is changed as required, the eccentric quantity e can be adjusted.

An effect of the present exemplary embodiment has a feature that a crown adjustment force F1 does not generate a moment load in a bearing box of a roll and a nip reaction force is received by the roll shaft so that the roll may be operated like an ordinary roll.

In the first exemplary embodiment, a nip load is entirely applied to the inner flange part 40.3 of the end face flange. However, in the eccentric ring structure of the second exemplary embodiment, since the nip load, namely, a sheet pressing load can be simply and directly applied to an inner flange part 40.3 together in the roll shaft 9 through the eccentric ring, a load to an inner pipe flange is advantageously reduced so that a durability of the roll is improved.

The inner pipe flange part 40.2 generates an angle θ by the eccentric quantity e, however, since the bearing 30 is an automatically aligning roller bearing (an aligning ball bearing may be used), the bearing can be naturally rotated.

The eccentric quantity e is 0.2 mm or so. A deformation stress of the inner flange part 40.3 at a supporting point of the angle is located within the resiliency of a material. A material stress is small, so that the durability can be ensured.

### Third Exemplary Embodiment

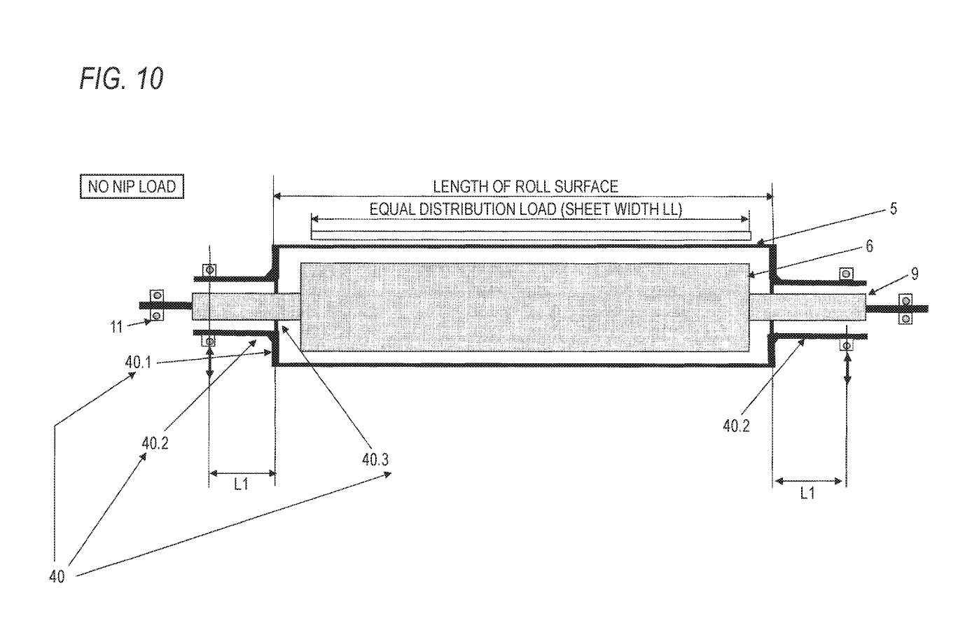

Hereinafter, a third exemplary embodiment will be described. The third exemplary embodiment is a modified example of the first exemplary embodiment in which an end face flange 40 is arranged outside and an inner flange part 40.3 is arranged in a position of an end face of a roll. Length L1 of an inner pipe flange part protrudes outside and is located in a position shown in FIG. 10.

An effect of the third exemplary embodiment resides in that a structure is simple and inexpensive. A function is the same as that of the first exemplary embodiment.

### Other Exemplary Embodiments

An arrangement of the third exemplary embodiment may be combined with the eccentric ring 32 of the second exemplary embodiment.

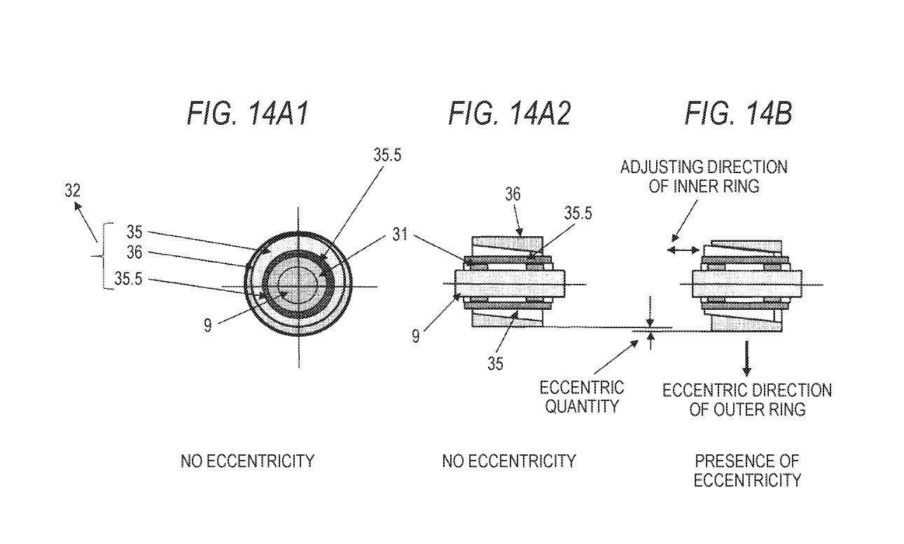

Further, as shown in FIG. 14, the eccentric ring 32 may have a slide structure system. Specifically, in the eccentric ring 32 of the second exemplary embodiment, the inner ring 35 and the outer ring 36 are rotated to adjust the eccentric quantity. However, an axis of the double ring of the eccentric ring 32 may be obliquely arranged and the inner ring 35 and the outer ring 36 may be relatively slid in the axial direction to adjust the eccentric quantity.

In FIG. 14, the eccentric ring 32 is formed with the outer ring 36, the inner ring 35 and a hollow shaft 35.5 and the inner ring 35 is pushed and pulled in the axial direction to adjust the eccentric quantity.

The eccentric ring 32 may be formed with a triple ring.

As the outer cell 5, the thin, metallic and rigid roll is exemplified, however, the outer cell may be applied to a roll having an intermediate cell thickness and a rigid roll. In the case of the rigid roll, all members are thick and a strength is increased, however, the inner flange part 40.3 is relatively formed with a thin structure.

In the first and second exemplary embodiments, the outer cell 5 is provided with the ring shaped or thread shaped grooves 12, however, a flat outer cell 5 having no grooves 12 may be applied to a resilient roll or a rigid roll.

The inner flange part 40.3 has the disk shaped thin plate structure, however, the inner flange part 40.3 may have a tapered form or a diaphragm form of a thin plate.

In the first exemplary embodiment, the pushing and pulling device 33 is arranged in the bearing box 11.5, however, the pushing and pulling device may be fixed to other fixing part to push and pull the end face flange 40.

In the first and second exemplary embodiments, the rotary joint is installed only in one side to provide a return type, however, a straight through type rotary joint may be used in which the rotary joint is arranged in both sides.

To connect the inner pipe flange part 40.2 to the thin inner flange part 40.3, a welding structure is exemplified, however, other free support structure such as a spherical surface support bearing may be used.

The welding structure is exemplified to connect the inner pipe flange part 40.2 to the thin inner flange part 40.3, however, the inner pipe flange part 40.2 and the inner flange part 40.3 may be integrally formed and cut.

In the above-described exemplary embodiments respectively, the outer cell 5 is formed with metal, however, the outer cell 5 may be formed with a carbon fiber reinforced compound material.

In the above-described exemplary embodiments, the outer cell 5 is applied to the thin, metallic and resilient roll, however, the outer cell may be applied to a rigid roll having a thick outer cell with a linear pressure of 30 kg/cm or higher.

In the first to third exemplary embodiments, the examples of the rolls for the thin film sheet having the thickness of about 0.1 mm are shown, however, the rolls may be applied to a sheet of a thickness of 0.1 mm or lower and higher.

A spiral plate may be provided in the outer periphery of the partition plate 44 and the inner cell 6 to supply a circulating flow in the temperature adjusting liquid.

The roll of the disclosure is applied to the sheet molding roll and a cooling roll, however, the roll may be applied as a crown adjusting function of other guide roll having no temperature adjustment, a winder ouch roll, a corona processing vent touch roll or the like.

The roll may be applied to a roll of other machines such as a sheet manufacturing machine or a printing machine.

The crown adjusting roll of the disclosure is described above in accordance with the plurality of exemplary embodiments. However, the disclosure is not limited to the structures described in the above-described exemplary embodiments and the structures may be suitably changed within a range which does not deviate from a gist of the invention by suitably combining the structures respectively described in the exemplary embodiments.

The disclosure exhibits below-described advantages.

1. The roll having no leakage of liquid is obtained as the crown adjusting roll.

Since the roll is entirely formed with metal without using a seal such as rubber or a resin, the roll can be obtained which has durability and can adjust a crown.

2. A temperature adjusting type roll is obtained.

Since temperature adjusting liquid is supplied to the roll and the roll is entirely formed with metal and has no seal, the temperature adjusting type roll can be obtained which has no leakage of liquid and can adjust the crown.

3. Since a crown adjusting mechanism and a roll nip pressurizing mechanism are independent, both the mechanisms can be adjusted without applying an influence to each other.
4. The roll is obtained in which the crown is adjusted so that a design linear pressure can be changed upward and downward.

The crown can be increased or decreased. Namely, the roll is obtained in which the design linear pressure can be vertically shifted. Further, a flat line pressure distribution can be vertically moved.

5. The crown is asymmetrically adjusted right and left to obtain a linear pressure distribution which is asymmetrical right and left.

When the disclosure is applied to the molding roll, a partly non-pressed part can be corrected so as to be partly strengthened and pressed.

Further, since a crown adjusting mechanism can be independently adjusted in right and left sides, the linear pressure in a rim part of an end of the sheet can be independently adjusted (pressurizing, reducing pressure) in the right and left sides.

6. The disclosure is most suitable for a pressurizing and molding roll for molding the resin sheet.

According to the disclosure, since the roll is a temperature adjusting liquid circulation type and the crown can be adjusted, the roll can be used for molding various sheets.

7. The roll has a cooling and heating ability to a molding material.

The temperature adjusting liquid can be supplied in the roll. Further, since the cell is formed with metal, the roll can be obtained which is higher in its cooling and heating ability than a rubber roll.

Further, since grooves or irregularities are formed in an inner surface of the outer cell, a contact area with the temperature adjusting liquid is large, so that a roll cooling and heating ability is high.

8. A thinner sheet can be manufactured by the roll than by a related-art rigid roll.

Since the present roll is a resilient roll mainly having a thin outer pipe, even the thin sheet can be flexibly pressed and molded or formed. Thus, a thin film sheet can be manufactured.

9. In the flow of the temperature adjusting liquid supplied in the roll, a uniform flow velocity is obtained over an entire part of the width of the roll.

In the long roll, a long end face flange is provided and the flow of the temperature adjusting liquid is complicated, however, the partition plate is provided. Accordingly, the uniform temperature adjusting liquid can be circulated on the entire part of the surface of the roll.

10. Durability of the roll is increased.

Since the roll is a metallic roll having a simple and integrated welding structure, a rubber seal is not provided and operating parts are not present, so that durability is high.

11. Since the roll is high in its cooling ability as the molding roll, a high speed can be obtained.

When the roll is applied to a resilient roll having a thin and metallic outer pipe, the cell is thin in the resilient roll having the thin and metallic outer pipe and heat is easily transmitted between an external part and the temperature adjusting liquid, the cooling ability is high. Accordingly, the high speed can be achieved.

12. The roll is a crown adjusting roll low in its frictional resistance during a rotation and driving.

Since a seal part which comes into contact with the temperature adjusting liquid is not present except a rotary joint, there is little rotation and driving friction.

Further, since bearings are completely bearings, there is little rotation and driving friction.

Since the crown adjusting roll of the disclosure has a simple structure and can make various crown adjustments and has a property with high reliability, the crown adjusting roll can be preferably suitably applied not only to a use for a molding roll for manufacturing a resin film sheet, particularly, a thin resin film sheet, but also to a use for, for instance, a molding roll of various uses.

What is claimed is:

1. A crown adjusting roll comprising:
a cylindrical outer cell configured to pressurize a sheet,
wherein each of end portions of the roll comprises:
a roll shaft;
a first bearing configured to support the roll shaft;
an end face flange configured to support the outer cell on one of end faces of the roll at both sides of the outer cell, the end face flange comprising:
an outer flange part configured to fix the outer cell;
an inner flange part provided inside of the roll in a direction of width of the roll and fixed to the roll shaft; and
an inner pipe flange pipe that connects the outer flange part to the inner flange part; and
a second bearing configured to support the inner pipe flange part, and
wherein the second bearing is configured to incline the end face flange on a center of the inner flange part as a supporting point, and the end face flange is inclined by a prescribed angle by applying a load in a direction intersecting at a right angle to an axial direction of the roll through the bearing by a pushing and pulling device such that a rotation moment is applied to an end face of the outer cell to adjust a crown.

2. The crown adjusting roll according to claim 1, further comprising:
a cylindrical inner cell provided in the outer cell and having an outside diameter that is smaller than an inside diameter of the outer cell,
wherein the inner cell is integrally formed with the inner flange part.

3. The crown adjusting roll according to claim 1,
wherein the inner piper flange part of the end face flange is extended outside in the axial direction of the roll from the outer flange part of the end faces of the roll, and
wherein the second bearing is provided outside in the axial direction of the roll from the inner flange part.

4. The crown adjusting roll according to claim 1,
wherein the pushing and pulling device is attached to a bearing box provided with the first bearing, and
wherein the bearing box is moveable and pressurizable in a pressurizing direction of the sheet by a pressurizing device.

5. The crown adjusting roll according to claim 1, further comprising:
a third bearing provided inside in a radial direction of the second bearing and configured to support the roll shaft; and
an eccentric ring fitted to an inner ring of the second bearing and an outer ring of the third bearing respectively,
wherein the eccentric ring has a double ring structure, a rotating position of the double ring is adjusted so as to adjust an eccentric quantity, and the eccentric quantity is adjusted to individually incline the end face flanges by angles of ±θ on the inner flange part as a center so that the rotation moment is applied to the end faces of the outer cell to adjust the crown of the outer cell.

6. The crown adjusting roll according to claim 5, wherein the eccentric ring has the double ring structure or a triple ring structure, an axial position of the ring is adjusted to adjust the eccentric quantity, and the eccentric quantity is adjusted to individually incline the end face flanges by angles of ±θ on the inner flange part as the center so that the rotation moment is applied to the end faces of the outer cell to adjust the crown of the outer cell.

7. The crown adjusting roll according to claim 5,
wherein the eccentric ring has the double ring structure comprising an inner ring and an outer ring, and the inner ring and the outer ring are respectively rotated to adjust the eccentric quantity and an eccentric direction and individually incline the end face flanges by angles of ±θ on the inner flange part as the center so that the rotation moment is applied to the end faces of the outer cell to adjust the crown of the outer cell.

8. The crown adjusting roll according to claim 1, wherein the second bearing is an aligning roller bearing or an aligning ball bearing having an aligning property.

9. The crown adjusting roll according to claim 1, wherein the end face flanges are configured to allow temperature adjusting liquid to be circulated in a space between the outer cell and the inner cell and to internally seal the temperature adjusting liquid by the end faces of the roll.

10. The crown adjusting roll according to claim 1, further comprising:
a cylindrical partition plate provided between the end face flange and the outer cell and configured to allow circulation of temperature adjusting liquid to an end part of the roll, the partition plate being installed such that one end of the partition plate is supported by the inner cell or the shaft at a center part of the roll.

11. The crown adjusting roll according to claim 1, wherein the inner flange part has a tapered shape or a diaphragm shape and is configured to incline the end face flange by a bending angle ±θ on the center of the inner flange part as the supporting point, and the end face flange is inclined by the pushing and pulling device or the eccentric ring such that the rotation moment is applied to the end face of the outer cell such that the crown of the outer cell is adjusted.

12. The crown adjusting roll according to claim 1, wherein the inner flange part is provided in a position of the end face of the outer cell or outside in the direction of width of the roll, and an inside diameter side of the inner flange part is fixed to the roll shaft or the inner cell.

13. The crown adjusting roll according to claim 1, wherein the roll comprises at least two pressing rolls, each of which is a crown adjusting roll for pressurizing and molding a resin sheet that pressurizes and molds a molten resin sheet.

14. The crown adjusting roll according to claim 1, wherein the roll is a thin, metallic and resilient crown adjusting roll for molding a sheet having a plurality of ring shaped grooves or thread shaped grooves formed in an inner surface of the outer cell.

15. The crown adjusting roll according to claim 1,
wherein a hole or a shaft of a tapered part, to which a working jig is fitted, is provided in an outside part in the end face flange of the end face of the roll or the inner pipe flange part in a longitudinal direction of the roll shaft, and
wherein the working jig has a hole at a center, the hole is fitted to the roll shaft, and a tapered part fitting part of the tapered part is provided on an outer peripheral part thereof, so that the rigidity of the end face flange and the outer cell is increased by integrally forming with the roll shaft at the time of working the roll.

16. The crown adjusting roll according to claim 1,
wherein a tapered part is formed at an outside part of the inner pipe flange part,
wherein the inner pipe flange part and the roll shaft configure a recess therebetween at the end face of the roll, and
wherein a working jig, an outer surface of which is formed to have a tapered surface and which has a hole at a center, is fitted to the recess such that the tapered surface of the working jig is fitted to the tapered part of the inner pipe flange part and the roll shaft is inserted into the hole.
